(19) United States
(12) Patent Application Publication
(10) Pub. No.: US 2019/0257685 A1
(43) Pub. Date: Aug. 22, 2019

(54) Transit Time Ultrasonic Meter Diagnostic System Displays

(71) Applicant: Kim LEWIS, Windsor, CO (US)

(72) Inventor: Kim LEWIS, Windsor, CO (US)

(21) Appl. No.: 15/739,135

(22) PCT Filed: Jun. 24, 2016
(86) PCT No.: PCT/US16/39179

§ 371 Date: Dec. 21, 2017

(51) Int. Cl. G01F 25/00; G01F 1/66

(52) U.S. Cl. CPC G01F 25/0007; G01F 1/667

(57) ABSTRACT

A new diagnostic display for ultrasonic flow meters is disclosed where a simple graphical box or similar structure is presented and icons are presented within the boundaries of the structure to indicate acceptable performance, replacing existing crowded displays.

### RELATED APPLICATIONS

This application claims priority to and is entitled to the filing date of U.S. Provisional application Ser. No. 62/184,004 filed on Jun. 24, 2015, and entitled “Transit Time Ultrasonic Meter Diagnostic System Displays.” The contents of the aforementioned application are incorporated herein by reference.

### INCORPORATION BY REFERENCE

Applicant(s) hereby incorporate herein by reference any and all patents and published patent applications cited or referred to in this application.

### TECHNICAL FIELD

The present disclosure relates to a system and method for providing diagnostic information for ultrasonic flow meters.

### BACKGROUND

An ultrasonic flow meter (USM) is a velocity flow meter that measures a volume flow rate of fluid flowing through a conduit such as a pipe. The fluid may comprise liquid, gas or a mixture thereof, and may also contain entrained solid matter. USMs are used in many different fields, including metering of hydrocarbon flows.

A USM comprises one or more pairs of ultrasonic transducers and defines one or more paths between transducers. A transducer emits an ultrasonic pulse which is received by another transducer after propagating along a path which runs across the fluid conduit, through flowing fluid. Each transducer can both transmit and receive pulses so that propagation along different path directions can be measured. If the difference between an upstream and downstream time of flight (Δt) between two points (of known distance apart) is measured, this will give the average fluid velocity along that path (u).

The transit time ultrasonic meter (USM) is promoted as having a good diagnostic system. The ability of the USM to ‘indicate when a problem arises’ is widely promoted as an integral part of an USM's capability.

An USM's set of diagnostic checks (or ‘diagnostic suite’) consists of a set of checks based on various physical principles. The diagnostic output is the combined results of these checks. USM diagnostics are not advanced enough for software to analyse the output and tell the operator if there definitely is or there definitely is not a problem, and if a potential problem is identified what that problem is. It is the meter operator that must decipher the meaning of the USM diagnostic output. The practical effectiveness of USM diagnostics is therefore dictated not only by the quality of the information supplied by the diagnostic system (as often inferred by USM manufacturers) but also the ability of the operator to understand the diagnostic outputs. If a flow meter's diagnostic output is too complicated or too ambiguous for an operator to understand, the diagnostics are of dubious practical use. A busy and complicated diagnostic display seriously hampers the operator's ability to quickly and easily absorb and understand any important information it may contain and act upon that information.

In most cases a flow meter operator is not a meter specialist, and has many other duties other than flow metering. Therefore, a crucial part of the practical use of USM diagnostics is simplicity and clarity in the presentation of the diagnostic results. There is little point having an advanced diagnostic system if the operator does not understand what the diagnostic results mean. Therefore, the USM diagnostic display, which exists to transfer the information from the diagnostic system to the operator, is very important. If the USM diagnostic display layout does not quickly and clearly indicate the vital information to the operator, the effectiveness and usefulness of the diagnostics is significantly diminished. A crucial step in making the relatively complex but valuable USM diagnostics available to the operator is to make the front diagnostic display as simple and as clear as possible.

With the display being critical to the process it is notable that the USM manufacturers do not discuss or significantly update/improve the diagnostic display regularly. USM manufacturers have not significantly updated or improved their diagnostic displays since the first generation meters years ago. The various USM manufacturers have diagnostic display screens that are variations on a theme. As subject specialists USM manufacturer engineering staff and salesmen know the present diagnostic display screens in detail. With extensive experience they know their way around these complicated screens by second nature. So established are these screens that nobody questions their appropriateness to the end user. The general principle of the present USM diagnostic displays is to offer the operator, i.e. typically individuals or a team who are not meter specialists, as much detailed information as possible in the front screen/s. So much information is supplied that some products need multiple layered screens to fit it all in. However, this is daunting to the typical operator.

### SUMMARY

Accordingly, there would be benefit to providing a display system for an ultrasonic meter that provides clear and unambiguous information rapidly to an unskilled operator, so that fail—conditions can be more quickly and easily identified and categorised, and that fail conditions are not overlooked.

According to a first aspect of the present disclosure there is provided a method of monitoring the performance of an ultrasonic flow meter comprising: representing a set of diagnostic checks as a parameter space with the or each axis of the parameter space representing a diagnostic check of the set; displaying the parameter space as a plot; representing on the plot an acceptable boundary condition for the or each diagnostic check in the set as a graphical boundary on each axis; wherein values plotted within a first region of parameter space defined by the graphical boundary indicate acceptable meter performance and values plotted within a second region of parameter space defined by the graphical boundary indicate that the meter may not have acceptable performance.

A parameter space is a set of values of a parameter or of the possible combinations of values for a plurality of different parameters which model a particular aspect of an ultrasonic flow meter. Ranges of values of the parameters form the axes of the plot. The parameters may be a direct representation of an ultrasonic diagnostic measurement check or a measure derived therefrom, with appropriate scaling and/or normalisation if required.

Plotting the parameter space graphically may be done using a computer, as part of a computer-implemented method. Note that a set of one is possible, i.e. the plot can have a single axis representing the value of a single diagnostic check (or a measurement derived therefrom).

Optionally, the acceptable boundary condition comprises magnitude lower bound and an upper bound.

When the parameter space is plotted on a single axis, the graphical boundary may comprise one or more single values on a line. In that case, a first region defined by the boundary that indicates acceptable meter performance may be a region where the value is less than the boundary value, or alternatively a value that is greater than the boundary value. Similarly, a second region defined by the boundary that indicates that the meter may not have acceptable performance may be a region where the value is greater than the boundary value, or alternatively a value that is less than the boundary value.

When the parameter space is plotted on a single axis and has upper and lower bounds, a first region defined by the boundary that indicates acceptable meter performance may be a region within the bounds, and a second region defined by the boundary that indicates that the meter may not have acceptable performance may be a region outside the bounds (in either direction).

When the parameter space is plotted on two or more axes, a first region defined by the boundary that indicates acceptable meter performance may be an area, volume or higher dimension corollary in the parameter space, and a second region defined by the boundary that indicates that the meter may not have acceptable performance may be a region outside the area, volume or higher dimension corollary in the parameter space.

Optionally, a plurality of parameter spaces are plotted together on the same plot; and boundary conditions for each of the parameter spaces are normalised such that a graphical boundary of the plot represents acceptable boundary conditions for each of the sets of diagnostic checks represented by each parameter space.

Optionally, the parameter space for each diagnostic check is two dimensional and each point in the plot represents the values of a pair of diagnostic checks.

Optionally, the ultrasonic flow meter comprises a plurality of ultrasonic signal paths.

Optionally, when a diagnostic check comprises readings for a plurality of parameters, only the single parameter that demonstrates the worst performance is plotted.

Optionally, the selection of diagnostic checks to be included in each set is based on parameters that are physically related.

Optionally, the diagnostic checks to be included in each set are selected from a set of parameters that are physically related and which are fundamental parameters from within that set.

Optionally, the pair of diagnostic checks comprise two types of speed of sound diagnostic checks.

Optionally, a first speed of sound diagnostic check comprises verifying the operation of an individual path, and the second speed of sound diagnostic check comprises comparison of an average speed of sound reading from a plurality of paths with an external reference.

Optionally, the pair of diagnostic checks comprise two different velocity profile diagnostic checks.

Optionally, a first velocity profile diagnostic check comprises symmetry and a second velocity profile diagnostic check comprises a profile factor.

Optionally, a third velocity profile diagnostic check is plotted, said third velocity profile diagnostic check comprising a cross flow factor.

Optionally, the velocity profile checks comprise any two of: plot symmetry; profile factor; or cross flow factor.

Optionally, the pair of diagnostic checks comprises any two of: signal to noise ratio, gain, performance, or turbulence diagnostic checks.

Optionally, a plurality of pairs are plotted.

Optionally, a visual and/or audible alert is presented for a user when one or more values are plotted outside the graphical boundary.

Optionally, the alert comprises a change of color of the graphical boundary.

Other types of alert that may be used in place or in addition to this include the boundary flashing, an audible alarm, a text warning message (either on the diagnostic display or sent to the operator electronically via a communication system), or any combination of these.

Optionally, a main screen displays the plot, and more detailed diagnostic information is displayed on other secondary screens that can be interrogated by a user.

Optionally, a meter performance at a given time is used to set a diagnostic display baseline for the plot.

According to a second aspect of the present disclosure there is provided a method of metering flow through a conduit comprising obtaining a flow rate with an ultrasonic flow meter; and monitoring the performance of an ultrasonic flow meter by: representing a set of diagnostic checks as a parameter space with the or each axis of the parameter space representing a diagnostic check of the set; displaying the parameter space as a plot; representing on the plot an acceptable boundary condition for the or each diagnostic check in the set as a graphical boundary on each axis; wherein values plotted within a first region of parameter space defined by the graphical boundary indicate acceptable meter performance and values plotted within a second region of parameter space defined by the graphical boundary indicate the meter may not have acceptable performance.

According to a third aspect of the present disclosure there is provided a computer program product comprising instructions that, when executed on a computer cause it to receive as its inputs readings from an ultrasonic flow meter; and process those inputs to generate a display representative of the meter's performance by representing a set of diagnostic checks as a parameter space with the or each axis of the parameter space representing a diagnostic check of the set; displaying the parameter space as a plot; representing on the plot an acceptable boundary condition for the or each diagnostic check in the set as a graphical boundary on each axis; wherein values plotted within a first region of parameter space defined by the graphical boundary indicate acceptable meter performance and values plotted within a second region of parameter space defined by the graphical boundary indicate the meter may not have acceptable performance.

According to a fourth aspect of the present disclosure there is provided flow meter system comprising an ultrasonic flow meter, a computer and a display for showing a representation of the meter's performance; wherein the computer receives as its inputs readings from the ultrasonic flow meter and processes those inputs to generate a display representative of the meter's performance by: representing a set of diagnostic checks as a parameter space with the or each axis of the parameter space representing a diagnostic check of the set; displaying the parameter space as a plot; representing on the plot an acceptable boundary condition for the or each diagnostic check in the set as a graphical boundary on each axis; wherein values plotted within a first region of parameter space defined by the graphical boundary indicate acceptable meter performance and values plotted within a second region of parameter space defined by the graphical boundary indicate the meter may not have acceptable performance.

### BRIEF DESCRIPTION OF THE DRAWINGS

The present disclosure will now be described, by way of example only, with reference to the accompanying drawings in which:

FIG. 1 shows one typical USM diagnostic display;

FIG. 2 shows another typical USM diagnostic display;

FIG. 3 shows a generic ultrasonic meter with a single path shown;

FIG. 4 shows a sketch of fully developed velocity profile and correct path velocity ratios;

FIG. 5 shows four typical path arrangements for ultrasonic meters;

FIG. 6 shows a typical USM individual diagnostic display for a path speed of sound check;

FIG. 7 shows an example of single diagnostic result plotted on a number line;

FIG. 8 shows an example of multiple diagnostic results plotted on individual number lines;

FIG. 9 shows an example of eight diagnostic results in pairs on a two dimensional plot;

FIG. 10 shows an alternative main display for USM speed of sound diagnostics;

FIG. 11 shows the correct velocity distribution across a four path transit time ultrasonic meter;

FIG. 12 shows an existing USM velocity profile diagnostic display;

FIG. 13 shows an alternative main display for USM speed of sound and velocity profile diagnostics;

FIG. 14 shows a typical SNR diagnostic plot for a four path USM;

FIG. 15 shows a typical 4 path transit time ultrasonic meter gain diagnostic display;

FIG. 16 shows a typical four path transit time ultrasonic meter gain diagnostic display;

FIG. 17 shows a typical four path transit time ultrasonic meter turbulence diagnostic display;

FIG. 18 shows an alternative main display for generic USM diagnostic suite;

FIG. 19 shows an example of a proposed new operator friendly display;

FIG. 20 shows a screenshot of a typical USM diagnostic display;

FIG. 21 shows a “zeroing” of a diagnostic display;

FIG. 22 shows a published USM diagnostics screenshot in a disturbed flow condition;

FIG. 23 shows proposed USM diagnostic display in a disturbed flow condition;

FIG. 24 shows a USM diagnostics display when wet gas is present; and

FIG. 25 shows a proposed USM diagnostic display in a wet gas flow condition.

### DETAILED DESCRIPTION

### 1. Introduction

The reality that the vast majority (expected to be greater than 95%) of USM operators do not monitor USM diagnostics is now being realised. The ‘solution’ according to USM manufacturers tends to be better training of the operators, or to offer consultancy where the manufacturers who sold the USM will then be paid to decipher the output of the meter they sold to their client. The USM manufacturers take a position that there is nothing wrong with their diagnostic displays, it is the operators' fault for not trying hard enough to understand them. There has been no public discussion about simplifying and rationalizing the front USM diagnostic display to make it more accessible to the operator, i.e. the individuals it is really meant to be aiding.

This disclosure shows how the USM diagnostic output can be re-arranged and presented in a much simpler rational way that should finally bring the benefit of the diagnostics to the majority of USM operators.

It is proposed here that the present comprehensive diagnostic display screens could be kept for in depth analysis by subject specialists. However, it is proposed that it is not appropriate for the operator's front screen to contain all the information. There is a requirement for this information to be condensed, rationalized and presented in a simple user friendly front screen. The fine details should be kept back for secondary screens and specialist analysis. Such a front screen would condense and rationalize the vital core diagnostics into a simple user friendly display such that would allow the non-specialist operator to know at a glance if the meter was serviceable or unserviceable. This would be hugely beneficial to industry. This important step would open up USM diagnostics to all users, not just the minority (expected to be less than 5%) of operators that presently make use of these. The present disclosure proposes a method and a system for reducing the complex outputs of a USM diagnostic suite to one simple to understand plot. This process of developing a simple USM diagnostic display was not simple, if it was such a method would have been developed in the twenty years the USM has been on the market. In the words of Steve Jobs: “It takes a lot of hard work to make something simple, to truly understand the underlying challenges and come up with elegant solutions.”

There is a requirement for a USM diagnostic display rationalization. This rationalization should distinguish between the information that is necessary to be shown to the operator in the front screen and what information is superfluous for an initial diagnostic overview front screen. A significant amount of diagnostic outputs do not need to be shown in the front screen. They can be shown in other formats (similar to the present USM manufacturer screens) that can be accessed by meter experts for further detailed analysis. The information on the front screen should be selective and presented clearly and precisely. Clarity and precision can be achieved by reducing the number of diagnostic outputs displayed, optimizing their usage, reducing the number of displays, and enlarging the chosen display.

Due to the fact that most USM manufacturers use a similar/generic diagnostic suite a common architecture for the proposed simplified front screen should be achievable with simple modifications for different USM designs. This would allow operators to learn to read this single communal front screen regardless of the USM manufacturer, thereby making it simpler for industry to discuss and understand USM diagnostic results. This is in sharp contrast with the present approach, where each USM manufacturer's diagnostic display is complex and unique to that manufacturer. Such a display could be created by software imbedded within a USM manufacturers software or created separately on a separate stand alone computer receiving inputs from a USMs computer system.

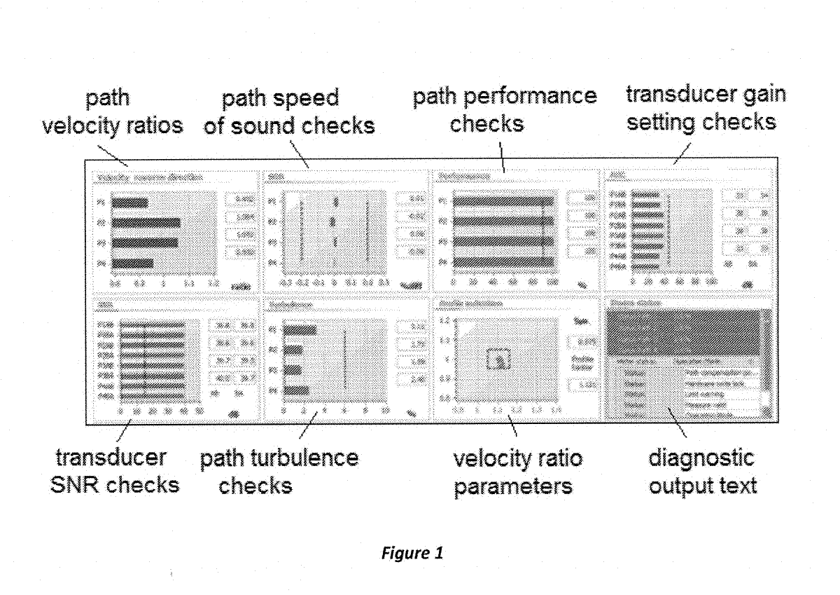

Some USM diagnostic display layouts have each diagnostic isolated into boxes or separate regions in the front screen display. An example of this is shown in FIG. 1 which illustrates one typical USM manufacturer's diagnostic display. Separate regions or boxes of the display are provided for each of the measured parameters that form the basis for diagnostic checks: path velocity ratios, path speed of signed checks, path performance checks, transducer gain setting checks, transducer SNR checks, path turbulence checks, velocity ratio parameters and diagnostic output text. This creates a busy screen with a huge amount of information, some of it, depending on the nature of a problem being irrelevant and distracting. In FIG. 1's screen shot there are seven separate boxes and within those boxes 36 different diagnostic results.

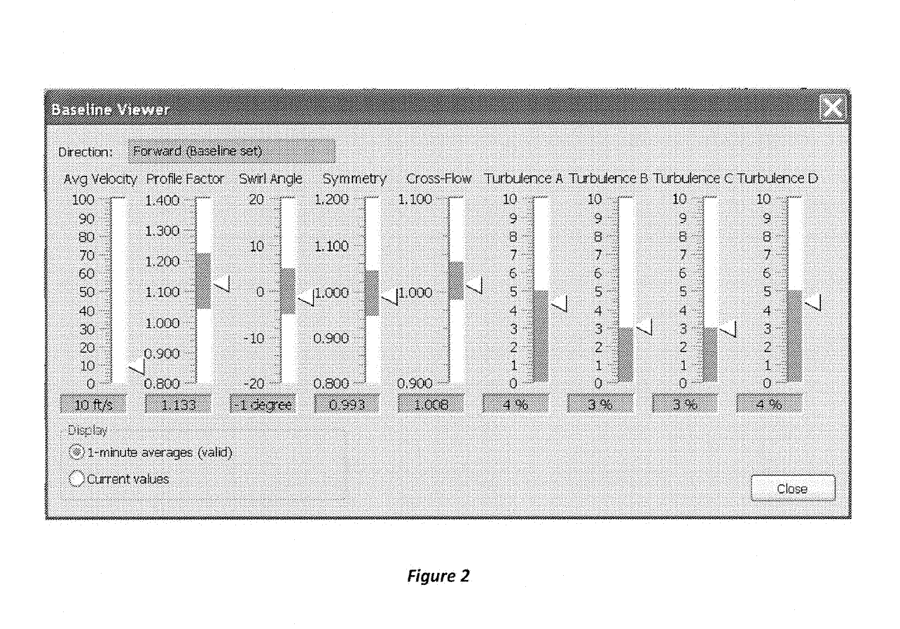

Other USM diagnostic display layouts show the diagnostic results in different layered screens. An example of such a layout is shown in FIG. 2. Here there is no one front screen, and any given ‘tab’ or screen does not show all the diagnostics, and can be missing the most relevant diagnostic result, for which the operator may have to actively search.

The elimination of these artificial barriers between the different sections allows for a diagnostic display where all the crucial information of the vital diagnostics are plotted together allowing the operator to get a relatively effortless, quicker and more accurate review of the overall diagnostic result and the health of the meter.

### 2. Generic Transit Time USM Operational Principles & Improved Diagnostic Display

The precise diagnostic suite of any USM is dependent on the design (i.e. number & position of paths) and the preference of the manufacturer. However, as previously stated they are variations on a theme. In this discussion we will consider the most popular gas USM design, the 4 path chordal meters. (It does not matter if the USM is a ‘Westinghouse’, ‘BG’ or other design). However, the modifications required for other designs will be obvious to those skilled in the art of USM diagnostics.

### 2.1 the Generic Operating Principles of a Transit Time USM

An ultrasonic wave moving downstream or upstream in a homogenous fluid flow moves at the SoS (‘SoS’) plus or minus the fluid velocity respectively. Hence, if the difference between the upstream and downstream time of flight (Δt) between two points (of known distance apart) is measured, this will give the average fluid velocity along that path (u).

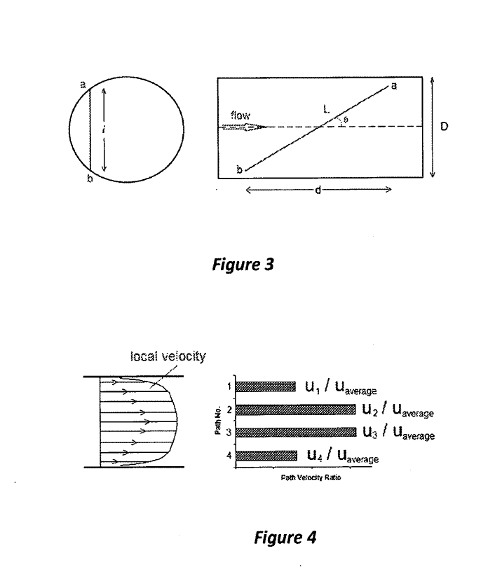

Consider the meter geometry shown in FIG. 3, which shows a generic ultrasonic meter with a arbitrarily positioned single path. Ultrasonic transducers are provided at points ‘a’ and ‘b’ which are provided a known distance apart at upstream and downstream positions and traversing a fluid conduit. Across the path shown the upstream (t_{ab}) and downstream (t_{ba}) transit times are calculated by equations 1 & 2 respectively. Note that ‘c’ and ‘u’ are the Speed of Sound (SoS) and the average velocity across that path.

$$\begin{matrix}{t}_{ab} = \frac{L}{c - u cos θ} & ( 1 ) \\ {t}_{ba} = \frac{L}{c + u cos θ} & ( 2 )\end{matrix}$$

Equations 1 & 2 are solved for the average velocity, i.e. see equation 3.

$$u = \frac{L}{2 cos θ} \frac{Δ t}{{t}_{ab} {t}_{ba}} = \frac{{L}^{2}}{2 d} \frac{Δ t}{{t}_{ab} {t}_{ba}} \qquad ( 3 )$$

It can also be shown that the SoS is found by equation 4.

$$c = \frac{L Δ t}{2 {t}_{ab} {t}_{ba}} \qquad ( 4 )$$

In reality, all fluid flows in pipes have a varying velocity across the cross section of the pipe. This is due to wall friction. For an undisturbed flow the velocity is maximum at the pipe centreline and is slower the closer to the wall. This is shown in FIG. 4, where can be seen that the local ‘velocity profile’ across a fluid conduit increases towards the middle of the conduit. Note that the ‘velocity profile’ is a generic term for a description of the velocity distribution across a pipe (or meter body) cross section.

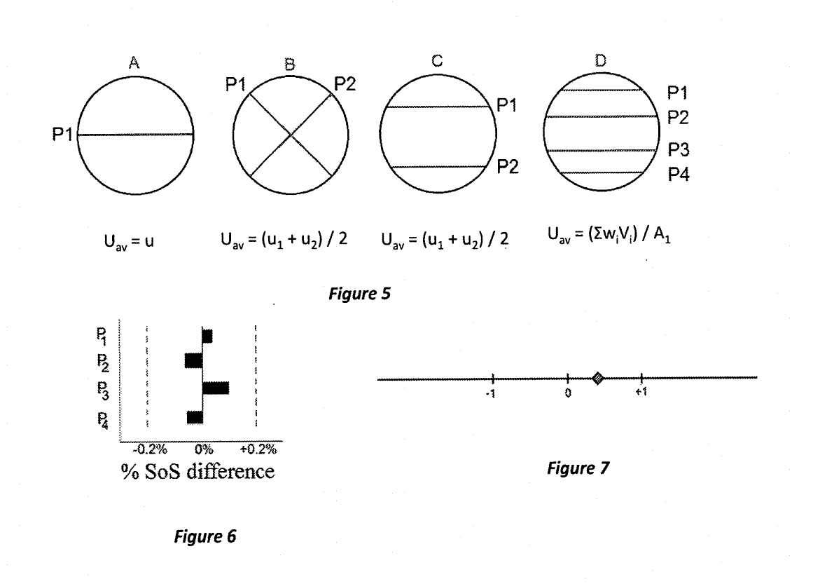

FIG. 5 shows typical path arrangements for ultrasonic meters. The method of averaging the individual path velocity measurements to the average flow velocity (uₐᵥ) is shown by the equations in the figure.

One of the most commercially popular USM path configurations is the four path design (D). The calculation relating the four individual discrete path velocities to the average flow velocity and volume flow rate is more complicated in this configuration. (In FIG. 5 Vᵢ represents volume flow and wᵢ represents a weighting fraction derived for a particular geometry, i.e. chordal positions).

Hence, the calculation of the true average velocity of the flow (uₒᵥ) is dependent on the number of paths and where these paths are located.

Regardless of the number of paths used, and whatever the chordal positions of those paths are, an ultrasonic meter is designed to predict the average fluid velocity through the meter. Hence, all ultrasonic meters predict the fluid volume or mass flow by finding the average velocity (uₒᵥ) and then applying the volume or mass flow rate equations 5 or 6 respectively.

$$\begin{matrix}Q = {A}_{1} {u}_{av} = {A}_{1} \frac{{L}^{2}}{2 d} \frac{Δt}{{t}_{ab} {t}_{ba}} & ( 5 ) \\ m = ρ Q = ρ {A}_{1} \frac{{L}^{2}}{2 d} \frac{Δ t}{{t}_{ab} {t}_{ba}} & ( 6 )\end{matrix}$$

### 2.2 the Generic Transit Time USM Diagnostic Suite

In the following discussion we will consider as an example the four path chordal design as shown in FIG. 5, drawing ‘D’. Other USM designs could be given the same, or similar data presentations.

### 2.2.1. Speed of Sound Checks

USM diagnostics include two SoS (‘c’) related checks. The first SoS check is to confirm the individual paths are operating correctly. Each path predicts the SoS (see equation 4) as well as the flow velocity (see equation 3) across that path. If there is a homogenous fluid flow (e.g. a clean dry gas flow or a clean constant composition liquid flow) all SoS measurements should agree to within a small allowable uncertainty.

USMs require the fluid properties to be supplied to the meter flow rate calculation from an external source. For a gas flow application this is usually achieved by use of a gas chromatograph (or ‘GC’), measuring the thermodynamic conditions (typically pressure and temperature), and then applying the known composition and thermodynamic conditions to an Equation of State (‘EoS’) calculation, which produces various fluid property predictions. Liquids can have their properties found from a look up table. The resulting EoS SoS prediction can be compared to the USM averaged path SoS prediction. There should be a good agreement between this external and meter SoS prediction. If there is not good agreement, and the meter SoS prediction is trustworthy (checked by the different paths SoS predictions agreeing to low uncertainty), this means that the independent fluid properties are suspect. Some USM diagnostic displays only show the averaged SoS diagnostic output. However, it is beneficial for both SoS checks should be shown.

Let us look at an example. Say the USM had 4 paths (n=4, where n is number of paths) the average SoS (cₐᵥ) would be Equation 7. Then each of the four path SoS predictions are compared to the average SoS, i.e. with Equation 8.

$$\begin{matrix}{c}_{av} = {\sum }_{i = 1}^{n} {c}_{i} / n & ( 7 ) \\ {x}_{i} \% = \frac{( {c}_{i} - {c}_{av} )}{{c}_{av}} * 100 \% & ( 8 )\end{matrix}$$

The American Gas Association Report 9 (‘AGA 9’), a popular USM standard for gas USMs, says no operational gas meter should have any individual path SoS prediction that differs from the average SoS by greater than ±0.2%. Hence, ±0.2% is the allowable variation around the average. Traditionally, USM diagnostic displays show each of the paths percentage SoS difference to the average value relative to the maximum allowed value (e.g. see FIG. 1 top row second from left). A typical plot is also reproduced in FIG. 6, which illustrates the difference in the SoS readings for each of the paths P1 through P4, with the allowable thresholds of +/−0.2% being shown as dashed lines showing a virtual boundary.

The second USM SoS diagnostic check is to compare the percentage difference in the meter's predicted average SoS (cₐᵥ) and the external SoS prediction (cₑₓₜₑᵣₙₐₗ), as calculated by Equation 9. There is a maximum operator assigned allowed difference. Some USM diagnostic suites carry out this calculation although not all show this result in the diagnostic display. (Note FIGS. 1 & 2 USM diagnostic screenshots do not show this diagnostic.)

$$y \% = \frac{( {c}_{av} - {c}_{external} )}{{c}_{external}} * 100 \% \qquad ( 9 )$$

In this four path example, there are five pieces of information in the SoS checks, i.e. the four individual SoS readings and the external SoS prediction. However, the front screen does not need to be cluttered with all this information. It can it be compressed. First, note that the two SoS checks are not entirely separate checks (as present USM diagnostic displays may infer). The second check (i.e. the meter vs. external speed sound comparison), can only indicate the external SoS is correct (and hence by association all required fluid properties are correct) once the first check (i.e. the individual path SoS check) has shown all four paths to be serviceable. If one or more of the paths have a SoS prediction >0.2% than the average, then that path has a problem, and the average value is therefore incorrect. If it is already known that the average SoS prediction is erroneous then a comparison with the external SoS prediction will also show an error. (It is still worth doing the second test, as you can compare the individual path SoSs to the external prediction thereby confirming the path with the problem.)

It is proposed that all that is required on the front screen is a plot of the worst case. If the path with the largest difference between the individual and averaged SoS prediction is still less than the allowed difference (typically <0.2%) then it is automatically accepted that all paths have acceptable SoS predictions. Therefore, all that needs to be shown in the front screen is the largest magnitude result from equation 8.

How would this be plotted? The SoS information in FIG. 1 shows the meter SoS individual path checks, it does not show the meter to external prediction SoS check. The SoS information in FIG. 1 is crammed into a single box in a screen as one of eight different boxes. That is, all the diagnostic results are crammed into a screen. The relevant diagnostic results, which may be obvious enough to a meter specialist with years of experience, are obscured from the actual user, i.e. the non-specialist operator, by the less relevant data. FIG. 2 does not show the SoS diagnostics because in that USM software it is on a different screen. In these multi-layer screen displays what the diagnostic display shows is whatever the non-metering specialist operator sets it to show—not necessarily what is needed to be shown. Even if these SoS diagnostics were shown isolated as FIG. 6 it takes up significant space on a front screen display, and then would obscure other potentially important layered screens.

All the relevant diagnostic results need to be shown in the front screen, but for the front screen to be fit for purpose it must show a clear message, and as such the front screen cannot be cluttered. It is proposed that a rationalization of the required information from all the diagnostics be carried out.

As a first example, an individual type of diagnostic check can be plotted on a number line. This is illustrated in FIG. 7. Here, the expected diagnostic result for the correctly operating system can be designated as the zero value of the number line. The region on such a number line that lies at or inside boundary conditions can represent the region where the diagnostic check sees no problem. The boundary conditions may be represented by normalised values +1 and −1. Outside this region represents the diagnostic check seeing a potential problem may exist. In an alternative embodiment the boundary conditions may indicate an error, that is, the acceptable value must be less than (and not equal to) the boundary conditions.

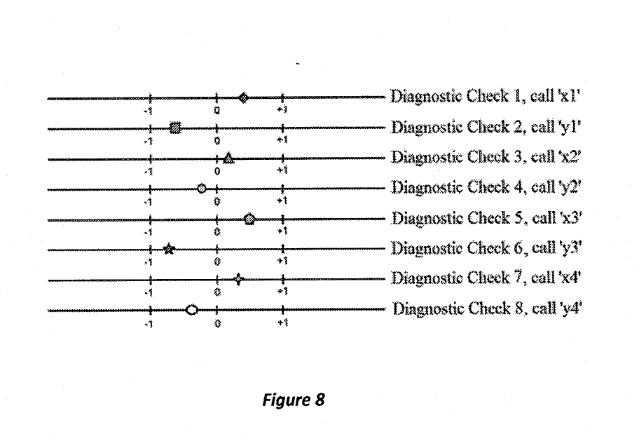

If multiple different diagnostic checks are available then these diagnostics could be plotted in a series of number lines. The series of number lines can be grouped together for display in any chosen pattern. One example pattern is the visual presentation of a stack of lines, as illustrated in FIG. 8, which shows a stack of eight diagnostic checks represented as number lines.

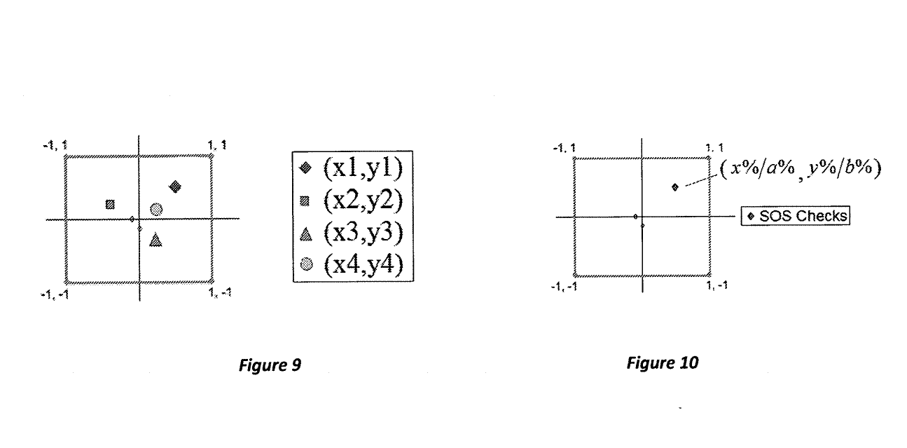

Alternatively pairs of diagnostics can be plotted as coordinates in a two-dimensional graph where the boundaries of acceptable performance are represented as values within a box with coordinates (+1,+1), (+1,−1), (−1,−1) & (−1,+1). An illustration of this technique is shown in FIG. 9, which shows for the example case of eight diagnostic results illustrative plotted values of pairings of the diagnostic checks x1 with y1, x2 with y2, x3 with y3, and x4 with y4 from FIG. 8.

If a pair of different diagnostic checks are available, as in this case with the two different speed of sound diagnostic checks then the essential information be plotted on a graph where the axes are two number lines (i.e. they represent no units) and the origin (or ‘cross—hairs’) represents the expected (i.e. calibrated) performance. Around the origin is a box of co-ordinates (+1,+1), (+1,−1), (−1,−1) & (−1,+1). Within the box the real performance is viewed as acceptable, i.e. within the calibration performance uncertainties. Outside the box the real performance is not acceptable, i.e. outside the calibration performance uncertainties.

Let us denote the allowable difference in the individual SoS predictions to the meter's averaged SoS prediction (Equation 7) as a %. AGA9 suggests a %=0.2% (although the operators could set this value at whatever they wish). Hence, the plot on the x-axis is xᵢ %/a %. However, there is no need to plot every path result on the front screen. The purpose of the front screen should be to give an initial summary to the operator of the health of the meter. The details can be held in secondary screens (such as the present diagnostic displays). Hence, only the largest absolute value of xᵢ %/a % needs be plotted. This can be plotted on the x-axis.

Let us denote the allowable difference in the meter's averaged SoS prediction (Equation 7) to the external SoS prediction as b %. Hence the plot on the y-axis is y %/b %, where y % is the percentage difference between the meter's averaged SoS prediction to the external SoS prediction (Equation 9). The y-axis has information from all paths embedded in it (via the averaged SoS prediction) but the x-axis contains only the information from the path with the worst performance, i.e. the path who's SoS prediction differs most from the average. If this point shows no problem it is automatically a given that no other path has a SoS issue either.

Therefore, instead of relying on the display of FIG. 6 (which only shows the path speed of sound checks and not the average meter to external speed of sound prediction comparison), the entire SoS diagnostic display can be represented as shown in FIG. 10. If the point is within or on the box there is no problem. If the point is outside the box it is a diagnostic indication that there is a problem with the SoS. If the point has the x co-ordinate within −1≤x≤+1 and they co-ordinate outside the range −1≤y≤+1 this indicates an incorrect external SoS (and by inference other fluid property) predictions. If the point has the x co-ordinate outside the range −1≤x≤+1 this indicates the meter SoS check has failed and this will likely cause the meter's averaged SoS to be erroneous, and hence different to a correct external SoS prediction. In turn this means the y co-ordinate will also be outside the range −1≤y≤+1. So an erroneous external SoS prediction is indicated by only the y-axis co-ordinate placing the point outside the box. A path SoS problem is indicated by both co-ordinates placing the point outside the box. That is, pattern recognition can indicate more information than an unspecified problem.

### 2.2.2. Velocity Profile Diagnostic Checks

The generic USM has three (or four) methods typically displayed to represent the individual path velocity measurement diagnostic checks. These are the individual path velocities, ‘profile factor’ and ‘symmetry’ (with some USM designs also showing cross flow.)

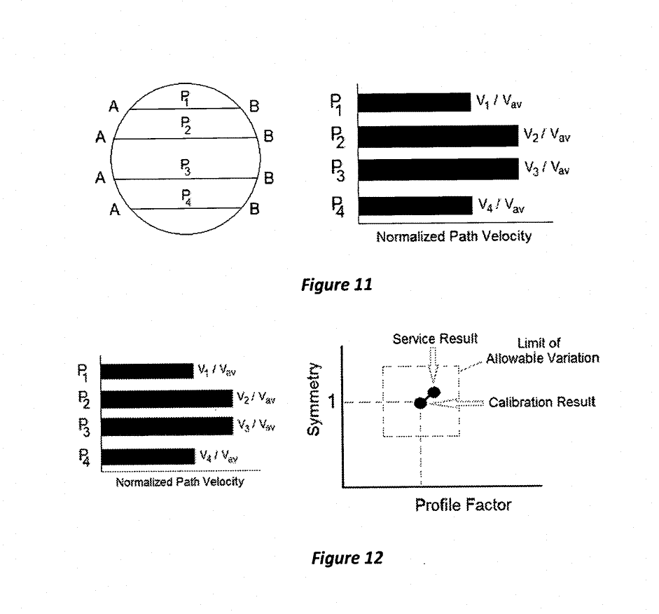

Due to frictional effects fully developed (i.e. undisturbed) flow in a pipe has a higher velocity in the centre of the pipe than close to the pipe wall. For the vast majority of gas flow applications the velocity is high enough to produce a ‘turbulent velocity profile’, i.e. a known velocity distribution across the cross sectional area of the pipe/meter body. This turbulent velocity profile (i.e. velocity distribution) is a relatively constant shape across a very wide range of velocities. As the USM paths are spread height wise across the pipe they will measure different velocities, as shown in FIG. 11. The relationships between these individual velocities should remain relatively constant across the wide gas flow range that produces a turbulent velocity profile. This can produce three related diagnostic outputs:

### Individual Path Velocity Checks

The USM manufacturers take the individual path fluid velocity readings and predict the over all average gas velocity, Vₐᵥ, (by Gaussian Integration mathematical techniques). As the individual gas velocities obviously change with gas flow rate, but the relationship between the individual gas velocities do not change with flow rate, the USM manufacturers tend to look at this relationship more often than the raw velocity readings. The individual path velocity readings (V₁, V₂, V₃, . . . Vₙ) are ‘normalized’ by dividing each one by the meter's average velocity prediction, Vₐᵥ. The normalized path velocities are commonly called ‘path ratios’. For a fully developed turbulent velocity profile, each individual path's normalized velocity should remain approximately constant. The precise path velocity ratio values dependent on the position of the paths. Paths 1 & 4 are closest to the wall and hence friction has a greater effect, meaning these local velocities are less than the average overall average gas velocity. Paths 2 & 3 have less ‘wall effect’ and the local velocities are higher than the average gas velocity.

Different manufacturers show the velocity ratios in different ways, but most show a plot like that in FIG. 1's top left corner graph. (The orientation can change but it is the same plot). Some USM manufacturer show a plot on their main diagnostic display such as that presented on the right hand side of FIG. 12. Here, the measured normalised path velocities are shown in the graph on the left hand side while the plot on the right hand side plots a profile factor against the measured symmetry of the path ratios. The measured service result is compared to a calibration result and a box represents the limit of allowable variation so that an operator can tell if the measured service result is outside of the normal limits which are allowed. Deviation from the standard set values of any individual normalized velocity is seen as a diagnostic alarm.

### Profile Factor

The profile factor is a diagnostic tool. The profile factor effectively checks the relationship of the inner & outer pair of path ratios. The profile factor (Φ) is defined by equation 10.

$$φ = \frac{( {V}_{2} / {V}_{av} ) + ( {V}_{3} / {V}_{av} )}{( {V}_{1} / {V}_{av} ) + ( {V}_{4} / {V}_{av} )} \qquad ( 10 )$$

If the flow has a fully developed velocity profile, i.e. any disturbance induced upstream on the flow has been dissipated and the flow has settled down to a constant velocity profile, then as this produces set path velocity ratios, it will also then produce a set profile factor. That is, the profile factor (Φ) is a known constant value. A USM's particular profile factor constant value depends on the position of the paths. (This is why no value is shown in FIG. 12.) In operation the measured profile factor should not vary from the calibrated value by greater than a set maximum allowable percentage. If the profile factor does vary it suggests a disturbed velocity profile, and this can cause flow rate prediction error.

### Symmetry

The symmetry of the velocity ratios is a diagnostic tool. A fully developed velocity profile is symmetrical around the meter centreline. Hence, a fully developed velocity profile check is to check that this is so. (This requires the USM paths to be symmetrically spaced and most commercial USM products have such symmetrical path spacing.) The symmetry factor (α) must be unity, as defined by equation 11.

$$α = \frac{( {V}_{1} / {V}_{av} ) + ( {V}_{2} / {V}_{av} )}{( {V}_{4} / {V}_{av} ) + ( {V}_{3} / {V}_{av} )} \qquad ( 11 )$$

If the symmetry factor is not unity, it means the flow is not symmetrical around the centre line and hence the flow cannot have a fully developed velocity profile, i.e. the flow is disturbed. In operation the measured symmetry factor (α) should not vary from unity greater than a set maximum allowable percentage. If the symmetry does vary it suggests a disturbed velocity profile, and this can cause flow rate prediction error. (Note, due to manufacturing tolerance, some USMs have calibrated/baseline symmetry values that are not quite unity. In such a case the baseline value is the reference in which to compare operational symmetry values).

### Cross Flow

Some USM designs have path locations that allow a check for swirl via a ‘cross flow’ factor (χ). A fully developed velocity profile by definition has no swirl (radial velocity component). Unlike symmetry and profile factor checks cross flow can identify the presence of swirl. The definition of cross flow is shown in Equation 12. Fully developed flow should have a cross flow value of unity.

$$χ = \frac{( {V}_{1} / {V}_{av} ) + ( {V}_{3} / {V}_{av} )}{( {V}_{2} / {V}_{av} ) + ( {V}_{4} / {V}_{av} )} \qquad ( 12 )$$

If there is no swirl and the flow is symmetrical then cross flow will be the same as symmetry. If the cross flow factor is not unity, it means there the flow cannot have a fully developed velocity profile. In operation the measured cross flow factor (χ) should not vary from unity greater than a set maximum allowable percentage. If the cross flow factor does vary it suggests a disturbed velocity profile, and this can cause flow rate prediction error. The cross flow diagnostic check is only available on certain types of path configurations.

### USM Manufacturer Velocity Profile Diagnostic Displays

Different USM manufacturers present these diagnostics in different ways. It is common to show some form of either raw or normalized path velocities (such as the left hand side of FIG. 12). Some USM manufacturers present profile factor and symmetry (& perhaps cross flow) in a secondary screen, plotted against time. For example, one common USM design plots the profile factor and symmetry together in the front display screen as shown in FIG. 1, and reproduced in FIG. 12. On this plot both the set calibration (baseline result) and the actual found performance is plotted, creating a ‘bar bell image’. Surrounding the calibration point is a box representing the allowable variation of each of the actual found velocity profile & symmetry values before an alarm is set. This diagnostic display is busy and includes repeat information, i.e. the path velocity ratios and symmetry vs. profile factor hold the same information, just in a different format. This is an example of USM manufacturers trying to put all the information onto the front screen and cluttering it in the process. Meter operators could benefit from a rationalization of what information needs to be on the front screen, and what does not. Furthermore, the presentation of this information could be simplified for clarity to the non-specialist meter operator.

### Proposed USM Manufacturer Velocity Profile Diagnostic Displays

A fully developed velocity profile is symmetrical. If the diagnostics show the velocity profile not to be symmetrical then the velocity profile is disturbed. However, a disturbed flow can still be symmetrical while having the wrong shape of profile factor/velocity profile. Therefore, the first check is for symmetry. If the flow profile is not symmetrical you will not get the correct profile factor. If the flow is symmetrical the next step is to check is the profile factor. An incorrect profile factor is not a guarantee of asymmetry. However, asymmetry is a guarantee of an incorrect profile factor.

This exercise is to rationalize the required information, find what information is truly required on the front screen, and to reduce the number of diagnostic outputs shown. The normalized path velocity ratio plot (shown in FIGS. 1 & 12) is a fundamental check that shows a rough picture of the velocity profile. However, the profile factor and the symmetry check are mathematical checks on the shape of that velocity profile using the information from the normalized path velocity plot. Hence, the profile factor and the symmetry check contain the vital information about the shape of that velocity profile.

In practice it is difficult to look at a path velocity ratio plot (i.e. left hand plot in FIG. 12) and clearly state if there is disturbed flow or not. Actual USM calibrations often show the meter has a slight profile factor and symmetry off set (for which the effect is calibrated out of the flow rate prediction) and in real time the individual velocity ratio values can fluctuate (a little). It can take a significant flow disturbance before it is clear from a velocity ratio plot alone that there is an issue. The combined effect is that it can be difficult to tell if there is a small to moderate issue by simply looking at the path velocity ratio plots. Systematic shifts in the symmetry, profile factor (and cross flow) are the mathematical way of indicating there is disturbed flow. Therefore the front screen should just show the symmetry vs. profile factor. (It could also show cross flow if the USM design has that check is available.)

The present manufacturer-produced plot (i.e. right hand side in FIG. 12) is still needlessly complicated. There is no need to show the ‘bar bell’. The calibration values can be represented naturally as the origin of a graph. The allowable uncertainty (or ‘variation’) of the calibration values can be represented by a box around the origin (again of co-ordinates ordinates (+1,+1), (+1,−1), (−1,−1) & (−1,+1). The actual symmetry and profile factor results can be plotted on that graph (after suitable mathematical transformation). If the point is within the box there is no problem. If the point is outside the box it is a diagnostic indication that there is disturbed flow, and therefore the meter flow rate prediction may be erroneous.

Let ξ% represent the percentage difference in a USM's symmetry value found in service (α_{service}) to the value set by calibration (α_{calibration}). We have:

$$ξ \% = ( \frac{{α}_{service} - {α}_{calibration}}{{α}_{calibration}} ) * 100 \% \qquad ( 13 )$$

Denote the allowable variation on % to be c %. The symmetry diagnostic check is now −1≤ξ%/c %≤+1.

Let δ% represent the percentage difference in a USM's profile factor value found in service (ϕ_{service}) to the value set by calibration (ϕ_{calibration}). We have:

$$δ \% = ( \frac{{φ}_{service} - {φ}_{calibration}}{{φ}_{calibration}} ) * 100 \% \qquad ( 14 )$$

Denote the allowable variation on δ% to be d %. The profile factor diagnostic check is now −1≤δ%/d %≤+1.

The symmetry & profile factor diagnostic checks can be plotted as (ξ%/c %, δ%/d %) on a graph with a box with corner coordinates ordinates (+1,+1), (+1,−1), (−1,−1) & (−1,+1).

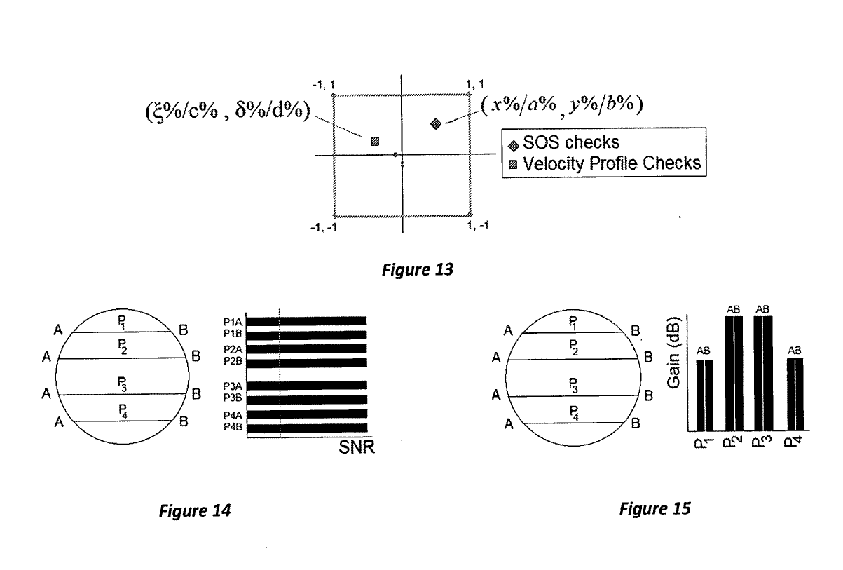

Now, instead of using two separate path velocity ratio plots (as shown in FIG. 12), and a separate graphs for the meter SoS checks (as shown in FIG. 6), both SoS checks (i.e. inclusive of the meter to external SoS prediction previously not always included in the front diagnostic screens) and the essential path velocity ratio information can all be shown in one simple graph. This is shown in FIG. 13 which illustrates an alternative front display for USM SoS and velocity profile diagnostics in accordance with present disclosure. The SoS and velocity profile checks are represented with a single point each, and the meter is deemed to be serviceable if each of these checks is within the bounds of the normalised diagnostic box.

It is possible to add the cross flow diagnostic check as another point (on the x-axis or y-axis) on FIG. 13. It would also be possible to pair any the cross flow result with either or both of the symmetry and/or profile factor result, but as not all USM designs have cross flow checks it has been left out in this illustrative example.

2.2.3. Signal to Noise. Gain. Performance & Turbulence Diagnostic Checks

All USM diagnostics are inter-related. In general, any arbitrary set of two diagnostic checks can be paired for plotting on a two-dimensional display (or a set of n diagnostic checks can be grouped for plotting on an n-dimensional display).

However, in some cases there are certain diagnostic checks that are useful to pair together. The two SoS diagnostics checks, and the two main velocity profile diagnostic checks are both suitable candidates for pairing, as described above. Three of the four remaining common USM diagnostics are inter-related. It is desirable to make pairs of these diagnostic checks in order to plot each pair in the (x,y) co-ordinate style of FIG. 9. Nevertheless, the most appropriate pairing of the remaining four main diagnostic checks is not obvious. Before discussing pairings it is first necessary to review these four diagnostic checks.

### Signal to Noise Diagnostic Check

USMs operate by a having pairs of piezocrystal transducers facing each other at a known distance. One transducer produces an ultrasonic wave and the time for the paired transducer to receive the signal (i.e. the time for that wave to travel to the paired transducer) is measured. The receiving transducer sends back an ultrasonic wave and the time for the paired transducer to receive the signal across that same path is measured. The difference in the two ‘transit times’ is directly related to the fluid velocity across the path of the ultrasonic wave.

The transducers produce an ultrasonic wave signal of known strength. Between sending and receiving signals the transducers pick up background ultrasonic noise occurring naturally in the system. The strength of this background noise is noted. If this becomes excessively strong it can interfere with the meter's operation. One diagnostic check is to monitor each path's signal to noise ratio (SNR) in both directions.

The greater the noise relative to the signal strength the smaller the SNR. In this case the bigger the SNR the better the meter is performing. FIG. 14 shows a typical USM SNR display (also shown in FIG. 1 bottom left graph). The SNR for each transducer (A and B for each of P1 to P4) is represented graphically by the horizontal bars. The vertical fine line indicates the minimum SNR setting allowed.

In contrast to this, it is proposed to provide a diagnostic plot which puts the essential SNR information on a simple graph centred at the origin (i.e. the cross hairs) as the best performance. We wish to present lower noise as closer to the origin. There are various ways of arranging the diagnostic analysis to show this. Here is one example.

Let η% denote the percentage difference between the actual SNR found in service and the baseline/expected SNR, as shown as Equation 15.

$$η \% = ( \frac{{SNR}_{service} - {SNR}_{expected}}{{SNR}_{expected}} ) * 100 \% \qquad ( 15 )$$

The expected SNR is rather arbitrary. It could be set by calibration or by some standard default value, but it would most likely be set at the meter start up at the actual installation. There can be significant differences between the background noise for the meter (with set signal strength) installed at the calibration laboratory and field installation. Hence, it is most appropriate to set the expected SNR during commissioning of the meter in the field. The meter operator has to set the maximum difference allowed between the actual and set expected value, e %. The diagnostic plot co-ordinate would then be η%/e %.

A four path USM has eight SNR values, i.e. a SNR value for each of the two transducers in a path. The SNR value for any transducer is influenced by various factors, such as average flow velocity, if it faces upstream (lower SNR) or downstream (higher SNR) & if it is positioned in an outer 1 & 4 path (lower SNR) or inner 2 & 3 path (higher SNR). As such, there is not one single representative value of SNR_{expected}, or e %: these values will be specific to flow velocity, transducer position & possibly installation. Each transducer will would have a specific relationship between velocity and the value η%/e %.

Technical papers on USM diagnostics say that the USM SNR diagnostic check tends to be less used than other USM diagnostics. SNR is not often a great concern to the USM operator, as a low SNR does not necessarily adversely affect the meter until the noise gets so excessive that signals begin to get lost (when the ‘performance’ check and ‘gain’ check will also show a problem). SNR is often used as a secondary diagnostic check to back up these other diagnostic results.

Although a four path USM has eight SNR values, a front screen, presenting the over-view of the diagnostic suite should not be cluttered with all eight SNR diagnostic checks (as is done by present displays, e.g. FIG. 1 bottom left plot). If all eight SNR values are okay there is no need to show all eight. Again, as with SoS checks, the front diagnostic screen could be simplified by only showing the worst performance of the eight SNR checks. By default, if that check is okay then all SNR checks are okay. If one or more SNR checks are not okay, then the worst case that is plotted will correctly and clearly indicate that the operator needs to look into the SNR issues without cluttering the front screen any further than necessary.

### Gain Diagnostic Check

Each USM transducer should produce a constant ultrasonic wave strength. If any transducer's strength is seen to be reduced, the meter system automatically boosts the strength. This is called increasing the ‘gain’. Naturally, transducers are not designed to normally operate at maximum power, or maximum ‘gain’, and transducers have a maximum power/gain setting which is usually substantially larger than the normal operational settings.

Each transducer in a path has a gain setting automatically selected by the system. If the system finds the signal received from a transducer weak it will automatically increase the power/gain of that transducer. A 4 path USM has 4 pairs of transducers, i.e. eight transducers and eight gain settings. A correctly operating USM does not have the same gain values on all eight transducer. The outer 1 & 4 paths have a lower gain setting as the ultrasonic wave has a shorter transit than for the case of the inner 2 & 3 paths.

A typical 4 path USM gain diagnostic display for a correctly operating USM is shown in the right hand diagram of FIG. 14, which shows the eight gain values for each transducer (A and B) of the paths P1 to P4. The gain of the four outer transducers (on paths 1 & 4) are approximately equal. The gain of the four inner transducers (on paths 2 & 3) are approximately equal.

The gain of any transducer is influenced by flow conditions (i.e. it can vary with pressure and fluid velocity without any metering problems existing). For example, one USM manufacturer published a paper showing that the normal gain settings for their 4 path USM was approximately 31 dB for the outer paths 1 & 4 & approximately 37 dB for the inner paths 2 & 4 when the average flow velocity was at 23 ft/s. But by 154 ft/s (which is a very high velocity in industry) the gain changed to approximately 35 dB for the outer paths 1 & 4 & approximately 41 dB for the inner paths 2 & 4. That is a 19% rise in gain for the outer paths and an 11% rise in gain for the inner paths. It should be possible to compensate for some of this gain by naturally increasing the expected baseline gain dependent on the line pressure and USM fluid velocity prediction.

The gain of any transducer is also influenced by adverse flow conditions or transducer faults (e.g. it will vary if there is transducer contamination, excessive noise or two phase flow). The effect on gain of pressure & fluid velocity is relatively small compared to significant metering problems. In the same paper as mentioned above an USM is exposed to disturbed flow, i.e. an abnormal velocity profile. With the abnormal velocity profile the gain settings shifted significantly from a non-disturbed flow value of 33 dB to approximately 27 dB for the outer paths 1 & 4, & from a non-disturbed flow value of 38 dB to approximately 30 dB for the inner paths 2 & 4. That is an approximate 21% fall in gain for all paths. This is not a significantly bigger gain shift than velocity effects unless the velocity effects are compensated for, which is quite achievable from calibration data. In that case, the gain diagnostics would certainly highlight a problem.

Let, γ% be the shift in a transducer's gain. Denoting gain as ‘μ’ this is calculated by:

$$γ \% = ( \frac{{μ}_{service} - {μ}_{expected}}{{μ}_{expected}} ) * 100 \% \qquad ( 16 )$$

The expected gain for a given transducer (μ_{expected}) is usually characterized during the USM's commissioning. It would significantly aid the operator if the expected gain was set to be a function of the pressure and USM's velocity reading. The meter operator has to set the maximum difference allowed between the actual and baseline/expected gain value, f %. The diagnostic plot co-ordinate would then be γ%/f %.

Although a four path USM has eight gain values, a front screen, presenting the overview of the diagnostic suite should not be cluttered with all eight gain diagnostic checks. If all eight gain values are okay there is no need to show all eight. Again, the front diagnostic screen could be simplified by only showing the worst performance of the eight gain checks. By default, if that check is okay then all gain checks are okay. If one or more gain checks are not okay, then the worst case that is plotted will correctly indicate that the operator needs to look into the gain issues without cluttering the front screen any further than necessary.

### Signal Quality ‘Performance’ Diagnostic Check

Each USM transducer in a pair takes turns to send an ultrasonic wave across the path to its paired transducer. The time for each wave to cross the path is read. The meter then calculates the difference in transit time (Δt) between path AB & BA.

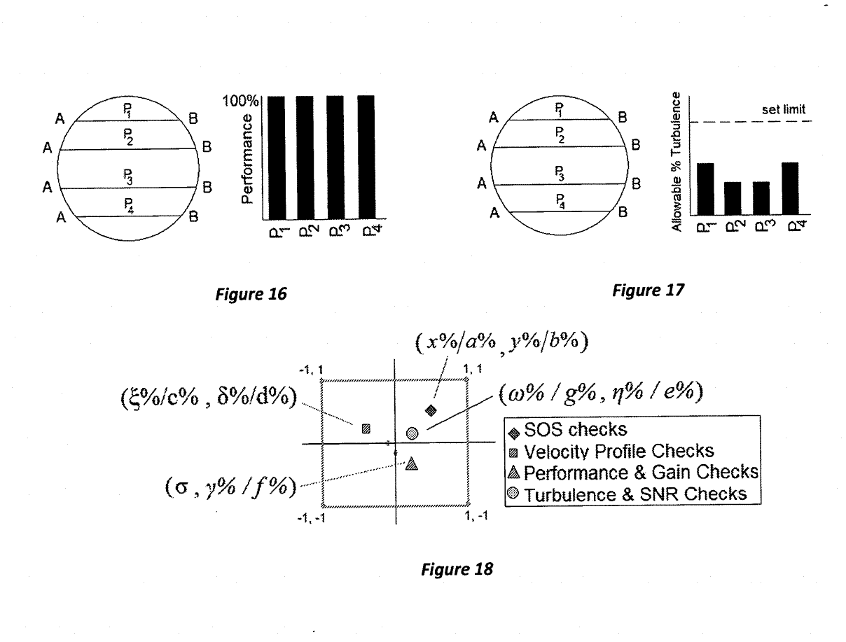

Each path has a ‘signal’ frequency, i.e. the number of attempted Δt readings per second. (This is not to be confused with the frequency of the ultrasonic transducers wave.) Path ‘performance’, is the percentage of the number of Δt measurements attempted per unit time that were successfully read. In effect it is a measure of the number of lost signals. USM manufacturers sometimes display the path performance as shown in FIG. 16 (see also FIG. 1 top, third from left), which represents the performance of each of the paths P1 to P4. The number of Δt measurements per second for each path can vary with USM design. As the Δt reading requires a pair of transducers the 8 transducers of a 4 path USM produces four path performances.

Under normal correct operation a path may read every Δt reading attempted. This is a path performance of 100%. However, as with gain and SNR, path performance is significantly affected by fluid velocity. One manufacturer published a technical paper showing the path performance of each path at 100% for 23 ft/s, but this reduced to about 90% at 154 ft/s. The USM was still fully functioning by using the 90% of readings it managed to obtain, i.e. the loss of 10% of the measurement due to excess attenuation of the signal in extremely high flow had no consequence to the meter's ability to correctly meter the flow. Again, it should be possible to compensate for some of this phenomenon by naturally reducing the expected path performance as the flow velocity increases beyond some critical velocity threshold where some signals are naturally lost.

Let, σ be the diagnostic result from a path performance diagnostic check. Denote the minimum allowed path performance value as ψₗᵢₘᵢₜ %. (It helps to relate the maximum performance degradation allowed, i.e. ψₗᵢₘᵢₜ %, to fluid velocity.) Denote the actual path performance value as ψ_{actual} %. The path performance check can be presented as Equation 17. Note that σ≥0.

$$σ = ( \frac{100 \% - {ψ}_{actual} \%}{100 \% - {ψ}_{limit} \%} ) \qquad ( 17 )$$

Although a four path USM has four path performance values, a front screen, presenting the overview of the diagnostic suite should not be cluttered with all four path performance diagnostic checks. If all four performance values are okay there is no need to show all four results. Again, the front diagnostic screen could be simplified by only showing the worst performance of the four performance checks. By default, if that check is okay then all path performance checks are okay. If one or more path performance checks are not okay, then the worst case that is plotted will correctly indicate that the operator needs to look into the performance issues without cluttering the front screen any further than necessary.

### Standard Deviation of Δt Signals (or ‘Turbulence’) Diagnostic Check

Each transducer pair in a path will create a number of transit time (Δt) readings per second. The precise number of readings depends on the signal frequency and path performance. No instrument reads a constant value. There is always some variance around a mean value even for nominally steady state measurements. This is true of USM transit time readings. The level of ‘variation’/‘bounce’/‘standard deviation’ of the transit time (Δt) readings (& hence path velocity readings) across a path are an indicator of flow issues and transducer health. The USM manufacturers tend to call this diagnostic check the ‘turbulence’ check. This is a poor name choice as flow ‘turbulence’ is a well defined fluid mechanics phenomenon that has nothing to do with this USM diagnostic check. Nevertheless meter engineers now accept this USM terminology.

With four path USMs, outer paths 1 & 4 have a higher standard deviation than the inner paths 2 & 3. This is due to the proximity of the paths 1 & 4 to wall effects. For example, one four path USM design's massed data sets showed outer paths 1 & 4 with a 4% variation in path velocity while inner paths 2 & 3 typically had a 3% variation in path velocity.

A typical USM manufacturer turbulence diagnostic display is shown in the right hand side of FIG. 17, which shows the allowable percentage turbulence for each of the paths P1 to P4, with an allowable set limit shown as a dashed horizontal line. To simplify this to the single graph concept, let co % be the percentage variation of fluid velocity (or Δt) reading across a path. That is, for a given set of Δt readings over a set period of time, analyse this data such that a velocity or Δt value can be found where the maximum and minimum values within this data set are +/−ω% above and below this value. Let that path's maximum allowable percentage variation of gas velocity (or Δt) be g %. The value of ‘g %’ must be decided by the operator. The diagnostic plot would therefore be ω%/g %. (Note by definition ω%/g %≥0).

Again, although a four path USM has four turbulence checks, a front screen, presenting the overview of the diagnostic suite should not be cluttered with all four turbulence diagnostic checks. If all four turbulence values are okay there is no need to show all four results. Again, the front diagnostic screen could be simplified by only showing the worst turbulence results of the four checks. By default, if that check is okay then all path turbulence checks are okay. If one or more path turbulence checks are not okay, then the worst case that is plotted will correctly indicate that the operator needs to look into the turbulence issues without cluttering the front screen any further than necessary.

### 2.2.4. Diagnostics Presentation

FIG. 13 shows a proposed representation of the SoS and velocity profile diagnostics as discussed above. It is now desired to add the performance, gain, signal to noise and turbulence diagnostics to this graph. These remaining four diagnostics can be paired to produce two more points on the graph. The pairing could be arbitrary, but it is beneficial to try and pair the two most related diagnostic checks.

Of these four diagnostic checks it is commonly considered that the performance and gain checks are the most powerful and useful of the diagnostic checks. The ‘turbulence’ diagnostics are a later (more modern) addition to the USM diagnostics suite. The turbulence and SNR checks are often considered to be secondary back up diagnostic that supports the main diagnostics. Hence, it is proposed the performance & gain diagnostics should be paired, and the SNR & turbulence diagnostics should be paired. That is we have the plot (σ, γ %/f %) for the performance & gain diagnostics pair, and we have the (ω%/g %, η%/e %) for the turbulence & SNR diagnostics pair. The proposed complete simplified front screen generic 4 path USM diagnostic display is shown as FIG. 18.

Note, it is not being suggested that any pairing of diagnostics are being in any way isolated from each other. All eight diagnostic checks are still plotted together on the graph. It is simply the case that to plot the eight diagnostic checks on one two dimensional graph we need to choose four pairs to produce four points with eight co-ordinates.

FIG. 18 shows a much clearer result for the non-specialist meter operator. Gone are the multiple separate plots (e.g. seven separate graphs in FIG. 1) and the mountain of detailed information (e.g. 34 separate pieces of information in FIG. 1). Gone are the layered multiple screens (e.g. FIG. 2). The rationalization process has reduced the diagnostic display to the simple and effective display of four points and a box. If all four points are in the box the meter is serviceable. If one or more points are out the box the meter may be unserviceable.

Furthermore, if one or more points depart the box the box can change in appearance, for example by turning from green to red or flashing, as a blatant warning to the non-specialist meter operator, that the diagnostics have found a problem. In sharp contrast to the present USM manufacturer's diagnostic displays, this is clear and easy for all operators to understand with minimal training and effort. Only if this front screen display indicates a problem does the operator have to then look into more diagnostic detail in secondary screens (perhaps the present complex USM diagnostic displays), or call for expert advice. Such is the simplicity of this display, it can open up the world of USM diagnostics to the majority of operators that presently ignore the USM diagnostic suite as an impregnable complex science.

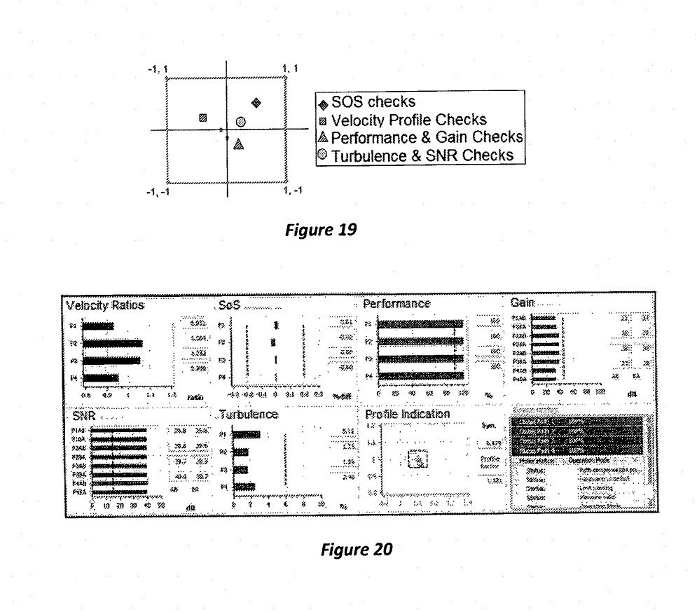

FIGS. 19 and 20 compare this proposed diagnostic display compared to a screenshot from one of the commercial USM products presently on the market. The two diagnostic displays essentially show the same important information. The new proposed display (FIG. 19) is clearly much simpler and quickly and easily lets the operator know at a glance that the meter is fully serviceable. The present USM displays (FIG. 20) have to be studied to confirm what the new display shows immediately.

The only detail in the original/present USM product diagnostic screens that is missing from the new simple plot is the breakdown of each path's individual diagnostics. However, this is detail that can easily be found from secondary screens once a problem has been found. This detail does not need to clutter the main front screen. Furthermore, the simple plot includes the second SoS check, which is not always included in the present USM manufacturer's screen. So, the simple screen even contains information the complex screen does not.

### 2.2.5 Zeroing the Diagnostic Display

USMs can be sensitive to installation affects. For example, AGA 9 advises that USM operators allow an increase in flow rate prediction uncertainty of 0.3% between the calibration settings and installation effects in the field. This is true of the meter's flow rate prediction and the diagnostic suite. Hence, although a USM diagnostic suite can be (and usually is) logged during the meter calibration, the diagnostic parameter settings can be slightly different between the calibration facility and the field without the meter necessarily having a significant problem.

Therefore, during field commissioning if the default diagnostic baselines are not agreeing with the meter performance, and the operator commissioning the meter is comfortable the meter is serviceable, it would be useful for an effective diagnostic display to be capable of easily shifting from the default calibration (or estimated un-calibrated) diagnostic settings to the ‘as found’ in service diagnostic performance. This can be termed ‘zeroing’ the diagnostic output. In this case, this would comprise taking the diagnostic points which would each be some distance from the origin, and carrying out a mathematical transformation such that each of the diagnostic outputs were converted to ‘zero’ at the performance of the meter at the instant of ‘zeroing’.

At the instant the diagnostic display is ‘zeroed’, and the diagnostic display converts from points around the origin (either inside or outside the normalised diagnostic box) to points on the origin, from that time on the diagnostic baseline would be the performance of the meter at the time the zeroing correction was applied. That is, from the moment the zeroing is applied the meter performance is compared to its performance at the time of zeroing.

This functionality is also useful for more clearly monitoring the severity of known problems. Say it is known the USM has a problem (e.g. contamination build up on the meter wall, wet gas, disturbed flow etc.) and the operator wishes to monitor the severity of the problem over time. It is considerably easier to do this if the meter performance at any given point of time can be set as the diagnostic display baseline (instead of the known correct performance) where it is represented as points on the origin of a graph. Then performance shift (i.e. the severity of the problem changing) is clearly and easily seen by the points drifting away from the origin. If the problem increases the points shift in one direction (i.e. the applied zeroing is not enough). If the problem decreases the points shift in the opposite direction (i.e. the applied zeroing is too much).

It is technically possible to monitor the existing standard USM diagnostic displays for such changes in performance induced by the changing severity of a known problem, but in reality they are so cluttered and the screens so small relative to the information they contain it is not a very practical proposition for the operator. It would take a dedicated specialist to post-analyse the data to clearly see such detail. In the new more user friendly USM diagnostic display disclosed here the zeroing technique makes such monitoring not just practical but in fact simple and easy.

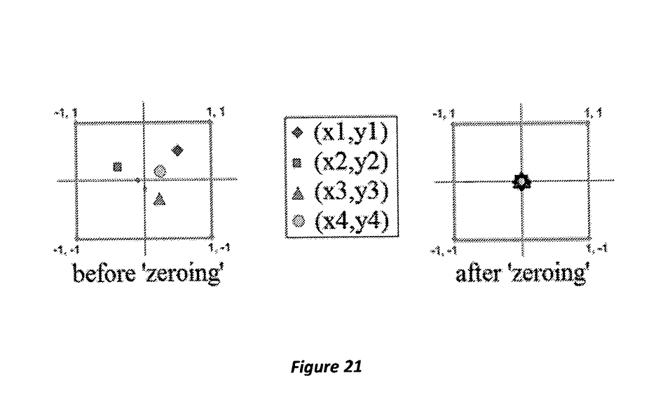

A zeroing technique is illustrated in FIG. 21, with a sample readout before and after zeroing (on the left and right hand sides respectively).

It has been shown that each diagnostic result can plotted as co-ordinate (i.e. specific number) on a number line. The position of the diagnostic result on this number line relative to the expected result (nominally set as at zero on the number line) indicates the diagnostic result. The diagnostic result indicating acceptable meter performance is set as a region on this number line (nominally the range between −1 & +1).

The process of ‘zeroing’ the diagnostics means reassigning the diagnostic result as the nominal reference performance. This means transforming the finite diagnostic value on the number line to zero by adding or subtracting the number required. This same transformation (i.e. the adding or subtracting of the same number) must also be applied to the acceptable meter performance region and all other diagnostic results on the number line. Such transformed diagnostic results are then all referenced to the diagnostic result that has been zeroed.

In the case of the proposed pairing of diagnostic results such that a co-ordinate (x,y) can be plotted on a graph, the action of zeroing means carrying out this mathematical transformation for each individual point. Such a mathematical transformation is now described for each of the four points' eight coordinates.

1. Internal Speed of Sound Check (x1):
At the instant of ‘zeoring’ the value of largest ‘xᵢ %’, i.e. the point furthest from zero which is the point selected to be plotted, sets the zeroing transformation by being the numerical value being locked. Let us denote it here as ‘x_{zero} %’. That is, x_{zero} % is the largest ‘xᵢ %’ at the time of zeroing. From then on, the diagnostic coordinate ‘x1’ will be plotted as:

$${x}_{1} = \frac{( {x}_{i , read} \% - {x}_{zero} \% )}{a \%}$$

where ‘x_{i,read} %’ is the largest of the internal speed of sound diagnostic checks read at any given time after zeroing.

2. External Speed of Sound Check (y1):
At the instant of ‘zeoring’ the value of ‘y %’ sets the zeroing transformation by being the numerical value being locked. Let us denote it here as ‘y_{zero} %’. From then on, the diagnostic coordinate ‘y1’ will be plotted as:

$${y}_{1} = \frac{( {y}_{read} \% - {y}_{zero} \% )}{b \%}$$

where ‘y_{read} %’ is the external speed of sound diagnostic check result at any given time after zeroing.

3. Symmetry Check (x2):
At the instant of ‘zeoring’ the symmetry value of ‘ξ%’ sets the zeroing transformation by being the numerical value being locked. Let us denote it here as ‘ξ_{zero} %’. From then on, the diagnostic coordinate ‘x2’ will be plotted as:

$${x}_{2} = \frac{( {ξ}_{read} \% - {ξ}_{zero} \% )}{c \%}$$

where ‘ξ_{read} %’ is the symmetry diagnostic check result at any given time after zeroing.

4. Profile Factor Check (y2):
At the instant of ‘zeoring’ the profile factor value of ‘δ%’ sets the zeroing transformation by being the numerical value being locked. Let us denote it here as ‘δ_{zero} %’. From then on, the diagnostic coordinate ‘y2’ will be plotted as:

$${y}_{2} = \frac{( {δ}_{read} \% - {δ}_{zero} \% )}{d \%}$$

where ‘δ_{read} %’ is the symmetry diagnostic check result at any given time after zeroing.

5. Performance Check (x3):
At the instant of ‘zeoring’ the value of largest ‘σᵢ’ shift relative to the set maximum allowable value, i.e. poorest performance the paths which is the point selected to be plotted, sets the zeroing transformation by being the numerical value being locked. Let us denote it here as ‘σ_{zero} %’. That is, σ_{zero} % is the largest ‘σᵢ’ at the time of zeroing. From then on, the diagnostic coordinate ‘x3’ will be plotted as:

x₃=σ_{i,read}−σ_{zero}
where ‘σ_{i,read} %’ is the largest of the internal speed of sound diagnostic checks read at any given time after zeroing.

6. Gain Check (y3):
At the instant of ‘zeoring’ the value of largest ‘γᵢ’ shift relative to the set maximum allowable value, i.e. largest (& hence most concerning) gain value which is the point selected to be plotted, sets the zeroing transformation by being the numerical value being locked. Let us denote it here as ‘γ_{zero} %’. That is, γ_{zero} % is the largest ‘γᵢ’ at the time of zeroing. From then on, the diagnostic coordinate ‘y3’ will be plotted as:

$${y}_{3} = \frac{( {γ}_{i , read} \% - {γ}_{zero} \% )}{f \%}$$

where ‘γ_{i,read} %’ is the largest of the gain diagnostic checks read at any given time after zeroing.

7. Turbulence Check (x4):
At the instant of ‘zeoring’ the value of largest ‘ωᵢ’ shift relative to the set maximum allowable value, i.e. largest (& hence most concerning) turbulence value which is the point selected to be plotted, sets the zeroing transformation by being the numerical value being locked. Let us denote it here as ‘ω_{zero} %’. That is, ω_{zero} % is the largest ‘ωᵢ’ at the time of zeroing. From then on, the diagnostic coordinate ‘x4’ will be plotted as:

$${x}_{4} = \frac{( {ω}_{i , read} \% - {ω}_{zero} \% )}{g \%}$$

where ‘ω_{i,read} %’ is the largest of the turbulence diagnostic checks read at any given time after zeroing.

8. SNR Check (y4):
At the instant of ‘zeoring’ the value of largest shift relative to the set maximum allowable value, i.e. the value which is the point selected to be plotted, sets the zeroing transformation by being the numerical value being locked. Let us denote it here as ‘η_{zero} %’. That is, η_{zero} % is the largest ‘ηᵢ’ at the time of zeroing. From then on, the diagnostic coordinate ‘y4’ will be plotted as:

$${y}_{4} = \frac{( {η}_{i , read} \% - {η}_{zero} \% )}{e \%}$$

where ‘η_{i,read} %’ is the largest of the turbulence diagnostic checks read at any given time after zeroing.

### Example 1: Asymmetric Flow

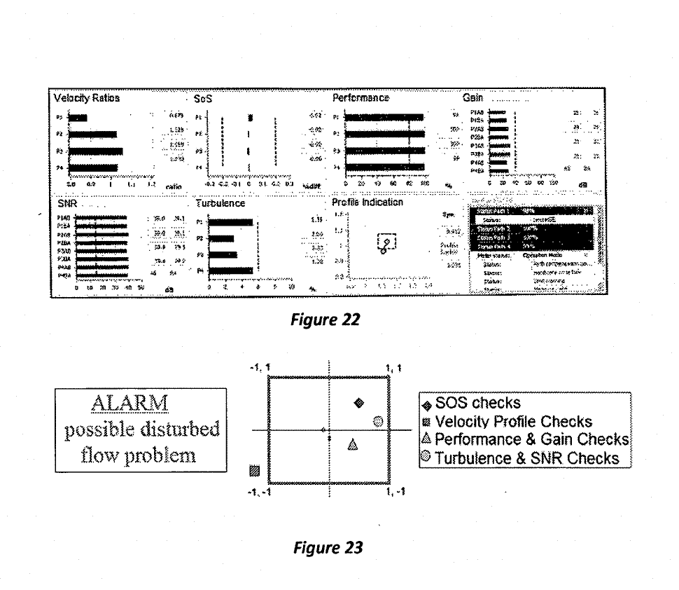

Considering the wide spread use of USMs throughout industry and the marketer's extensive use of USM diagnostic technology to promote USM products, there is a surprising lack of published screenshots of USM diagnostic screens as examples of these diagnostics in action. One rare publication is by Lansing J., “Understanding Gas Ultrasonic Meter Diagnostics—Advanced”, Appalachian Gas Measurement Short Course, Pittsburgh, Pa., USA, August 2013. In this paper a USM diagnostic screen is shown for a correctly operating four path USM (see FIG. 20). In this same paper a screenshot is also shown from when the meter was subjected to a disturbed (or ‘asymmetrical’) flow. This screenshot is reproduced as FIG. 22.

Here, from FIG. 22, the operator must decide what is wrong from the massed diagnostic results spread across seven graphs and a text box. The text box (bottom right box) does not state what the problem is, but rather gives notes on the serviceability of paths. An examination of the USM screen shows that the Velocity Ratios may show a problem, as it does not look very symmetrical. However, it is not conclusive as many serviceable meters are calibrated to show slightly no symmetrical baselines. (This is an example of why this author believes the velocity ratio information should solely be viewed via the profile factor, symmetry (and cross flow if available—not shown here). Looking through the next five graphs (left to right top to bottom) indicates no problem, until finally the seventh and final graph shows a potential velocity profile issue. This does then indicate (after some detailed review) that there may be an issue, but this issue is only shown by one graph, and not described in the text box. There are a lot of other diagnostic results obscuring the issue, most of the diagnostic checks on this front screen are not sensitive to the problem, and hence indicate no problem is found. This typical present diagnostic display inherently puts the onus on the operator to learn, practice and get experience with USM diagnostics in order to understand these subtle shifts in the array of information that confronts him.

The same data plotted on the new proposed rationalized screen is shown in FIG. 23. Here, one point is outside the box, so there is an alarm, the box has changed colour, i.e. the correctly operating meters newly proposed diagnostic display had a green box in FIG. 19 with all the points within the box. Here, in FIG. 22, when one point falls outside the box the box turns red as an aid to getting the operators attention. In practice the box could also flash, and other attention adding aids could be included. There is a useful text box appearing listing any problem known to cause a similar pattern. Clearly, it takes little training, and no detailed review of this result to know that the meter has a problem. Instead of a suitably trained individual having to dedicate some time to study the present diagnostic screen with this proposed initial diagnostic display the untrained operator can see at a glance there is a problem and gets some idea what the problem may be. This makes the diagnostics more practical, i.e. more accessible to the average operator. In turn this would make the practice of monitoring and benefiting from the diagnostic suite more widespread.

### Example 2: Wet Gas Flow

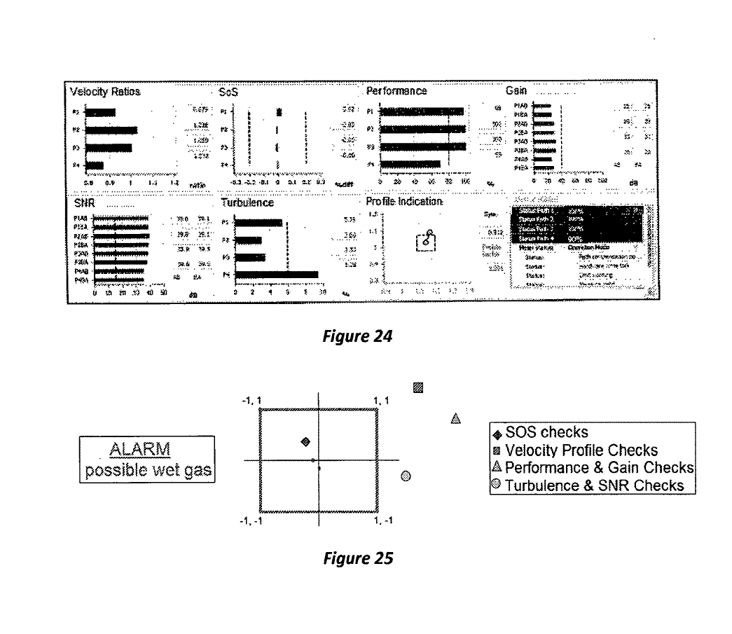

No full USM diagnostic suite screenshot has been published for wet gas flow but the enough information is in the public domain to create a typical screen (i.e. see FIG. 24). Wet gas is a very adverse flow condition for all gas meters, USM inclusive. It is important to identify the presence of liquid with a gas flow as it induces a significant gas flow rate prediction bias on the flow meter.

The reaction of a USM diagnostic suite to any adverse flow condition is dictated by both the type and severity of the problem. The USM diagnostics are shown here to have a more significant reaction to the wet gas than asymmetrical flow.

Note that the scale of the reaction is down to how severe any problem is. FIG. 24 is for a significant amount of liquid, approximately 0.5% by volume (and 10% by mass). Again the velocity ratio check suggests a problem but it's not conclusive. It is the symmetry (but not the profile factor) that shows a problem exists. Again, some diagnostic checks are just not sensitive to the problem i.e. SoS, Gain & SNR. (As with many USM operational problems, as the severity of an issue increases different diagnostic checks will begin to note a problem. However, at this liquid loading the problem is below the threshold of what these three diagnostic checks can see.) All this type of display does is cause these three diagnostics to obscure the relevant result, i.e. that there is a problem. The performance, turbulence and symmetry combine to show (a meter expert) that path 4 has a problem. This pattern is indicative of possible wet gas to the expert, Dot to the non-specialist.

The same data plotted on the new proposed rationalized screen is shown in FIG. 25. Here, three of the four points are outside the box, there is an alarm, and the box has changed colour (from green to red). There is a useful text box appearing listing any problem known to cause a similar pattern. Instead of a suitably trained individual having to dedicate some time to study the present diagnostic screen with this proposed initial diagnostic display the untrained operator can see at a glance there is a problem and gets some idea what the problem may be. This makes the diagnostics more practical, i.e. more accessible to the average operator. In turn this would make the practice of monitoring and benefiting from the diagnostic suite more widespread.

The author considers it self evident that this new and simple proposed USM diagnostic display makes USM diagnostics much more accessible to those that really need them, the non-meter specialist USM operators. This display is a significant advance in flow meter diagnostics accessibility to the end users.

Various improvements and modifications can be made to the above without departing from the scope of the disclosure. For example, the pairings of the eight diagnostics can be rearranged to give different pairings but similar plots and the same advantage. New diagnostic developments can be represented as further points on the plot. The shape of the boundary is somewhat arbitrary. It is possible to carry out a mathematical transformation to show the points on a circular boundary instead of a square boundary, such as the origin and the circle look like a ‘target’ or a ‘bullseye’.

Also, while the illustrated embodiments plot a pair of diagnostic checks in two dimensions, it will be appreciated that a triplet of diagnostic checks may be plotted as a point in a three dimensional space, which may be represented graphically. Such a three-dimensional representation may have a boundary represented by a cube, a sphere or some other object, with points inside the object representing satisfactory meter performance. The three dimensional representation may be interactive, with a user having the ability to rotate or pan the view of the represented space.

It is also possible to represent a single diagnostic check using the methods of the present disclosure. In that case, the plot that is displayed to a user may comprise a single line with one or more boundary markers. The value that is read will “slide” along the line, and if it goes beyond the boundary marker(s) then an error will be indicated.

The disclosure also applies to any type of transit time ultrasonic meter, including all intrusive and non-intrusive varieties (including clamp-on meters which use a reflector to reflect ultrasound between transceivers which are provided as part of a probe body), Doppler shift flow meters and open channel flow meters.

1-23. (canceled)

24. A method of monitoring the performance of an ultrasonic flow meter comprising:
representing a set of diagnostic checks as a parameter space with the or each axis of the parameter space representing a diagnostic check of the set;
displaying the parameter space as a plot; and
representing on the plot an acceptable boundary condition for the or each diagnostic check in the set as a graphical boundary on each axis,
wherein values plotted within a first region of parameter space defined by the graphical boundary indicate acceptable meter performance and values plotted within a second region of parameter space defined by the graphical boundary indicate the meter may not have acceptable performance.

25. The method of claim 24, wherein the acceptable boundary condition comprises a lower bound and an upper bound.

26. The method of claim 24, wherein:
a plurality of parameter spaces are plotted together on the same plot; and
boundary conditions for each of the parameter spaces are normalised such that a graphical boundary of the plot represents acceptable boundary conditions for each of the sets of diagnostic checks represented by each parameter space.

27. The method of claim 24, wherein the parameter space for each diagnostic check is two dimensional and each point in the plot represents the values of a pair of diagnostic checks.

28. The method of claim 24, wherein the ultrasonic flow meter comprises a plurality of ultrasonic signal paths.

29. The method of claim 28, wherein, when a diagnostic check comprises readings for a plurality of parameters, only the single parameter that demonstrates the worst performance is plotted.

30. The method of claim 24, wherein the selection of diagnostic checks to be included in each set is based on parameters that are physically related.

31. The method of claim 24, wherein the diagnostic checks to be included in each set are selected from a set of parameters that are physically related and which are fundamental parameters from within that set.

32. The method of claim 27, wherein the pair of diagnostic checks comprise two types of speed of sound diagnostic checks.

33. The method of claim 32, wherein a first speed of sound diagnostic check comprises verifying the operation of an individual path, and the second speed of sound diagnostic check comprises comparison of an average speed of sound reading from a plurality of paths with an external reference.

34. The method of claim 27, wherein the pair of diagnostic checks comprise two different velocity profile diagnostic checks.

35. The method of claim 34, wherein a first velocity profile diagnostic check comprises symmetry and a second velocity profile diagnostic check comprises a profile factor.

36. The method of claim 34, wherein a third velocity profile diagnostic check is plotted, said third velocity profile diagnostic check comprising a cross flow factor.

37. The method of claim 34, wherein the velocity profile checks comprise any two of: plot symmetry; profile factor; or cross flow factor.

38. The method of claim 27, wherein the pair of diagnostic checks comprises any two of: signal to noise ratio, gain, performance, or turbulence diagnostic checks.

39. The method of any claim 27, where a plurality of pairs are plotted.

40. The method of any claim 24, wherein a visual and/or audible alert is presented for a user when one or more values are plotted outside the graphical boundary.

41. The method of claim 40, wherein the alert comprises a change of color of the graphical boundary.

42. The method of claim 24, wherein a main screen displays the plot, and more detailed diagnostic information is displayed on other screens that can be interrogated by a user.

43. The method claim 24, wherein a meter performance at a given time is used to set a diagnostic display baseline for the plot.

44. A method of metering flow through a conduit comprising:
obtaining a flow rate with an ultrasonic flow meter; and
monitoring the performance of an ultrasonic flow meter by:
representing a set of diagnostic checks as a parameter space with the or each axis of the parameter space representing a diagnostic check of the set;
displaying the parameter space as a plot;
representing on the plot an acceptable boundary condition for the or each diagnostic check in the set as a graphical boundary on each axis,
wherein values plotted within a first region of parameter space defined by the graphical boundary indicate acceptable meter performance and values plotted within a second region of parameter space defined by the graphical boundary indicate the meter may not have acceptable performance.

45. A computer program product comprising instructions that, when executed on a computer cause it to receive as its inputs readings from an ultrasonic flow meter; and process those inputs to generate a display representative of the meter's performance by representing a set of diagnostic checks as a parameter space with the or each axis of the parameter space representing a diagnostic check of the set; displaying the parameter space as a plot; representing on the plot an acceptable boundary condition for the or each diagnostic check in the set as a graphical boundary on each axis; wherein values plotted within a first region of parameter space defined by the graphical boundary indicate acceptable meter performance and values plotted within a second region of parameter space defined by the graphical boundary indicate the meter may not have acceptable performance.

46. A flow meter system comprising an ultrasonic flow meter, a computer and a display for showing a representation of the meter's performance; wherein the computer receives as its inputs readings from the ultrasonic flow meter and processes those inputs to generate a display representative of the meter's performance by: representing a set of diagnostic checks as a parameter space with the or each axis of the parameter space representing a diagnostic check of the set; displaying the parameter space as a plot; representing on the plot an acceptable boundary condition for the or each diagnostic check in the set as a graphical boundary on each axis; wherein values plotted within a first region of parameter space defined by the graphical boundary indicate acceptable meter performance and values plotted within a second region of parameter space defined by the graphical boundary indicate the meter may not have acceptable performance.
